(19) United States
(12) Patent Application Publication
(10) Pub. No.: US 2024/0160583 A1
(43) Pub. Date: May 16, 2024

(54) HUMAN MACHINE INTERFACE HAVING DYNAMIC USER INTERACTION MODALITIES

(71) Applicant: Hewlett-Packard Development Company, L.P., Spring, TX (US)

(72) Inventors: Ravi Shankar Subramaniam, Palo Alto, CA (US); Adam Mendes da Silva, Sao Paulo (BR); Caio Jose Borba Vilar Guimaraes, Sao Paulo (BR); Hugo Tulio Maximiliano Secreto, Sao Paulo (BR); Henrique Sueno Nishi, Sao Paulo (BR); Joao Vitor Assis e Souza, Sao Paulo (BR); Leandro Mendes dos Santos, Sao Paulo (BR); Vinicius Trevisan, Sao Paulo (BR)

(73) Assignee: Hewlett-Packard Development Company, L.P., Spring, TX (US)

(21) Appl. No.: 18/550,074

(22) PCT Filed: Mar. 22, 2021
(86) PCT No.: PCT/US2021/023514

§ 371 Date: Sep. 11, 2023

(51) Int. Cl. G06F 13/10

(52) U.S. Cl. CPC G06F 13/102

(57) ABSTRACT

One example provides a human-machine interface (HMI) to receive interaction inputs including user interaction content representing different user interaction modalities (UIMs). The HMI includes a plurality of machine learning (ML) models corresponding to different UIMs to process user interaction content representing the corresponding UIM to provide model outputs. An interface manager dynamically adjusts a selected set of UIMs and a selected set of ML models to enable the selected set of UIMs based on monitoring of at least the user interaction content of the plurality of interaction inputs, and implements a user interface including ML models of a currently selected set of ML models interconnected with one another with an interconnect structure to convert user interaction content corresponding to the currently selected set of UIMs to operational inputs based on the model outputs of the currently selected set of ML models.

### BACKGROUND

Human-Machine Interfaces (HMI) enable interactions between users and machines, such as between users and computing devices, for example. Traditionally, HMIs have interfaced interactions between users and computing devices via physical input devices (such as keyboards, mice, and touchpads, for example) and physical output devices (such as displays, speakers, and printers, for example). Relatively recently, HMIs have expanded to enable so-called “virtual” or “non-tactile” interactions, such as voice (e.g., virtual assistants) and video inputs (e.g., face recognition for security), for example

### BRIEF DESCRIPTION OF THE DRAWINGS

FIG. 1 is a block and schematic diagram generally illustrating a human-machine interface, according to one example.

FIG. 2 is a block and schematic diagram generally illustrating a flow diagram of a user interface employing a number of user interaction modalities, according to one example.

FIG. 3 is a block and schematic diagram generally illustrating a flow diagram of a human-machine interface, according to one example.

FIG. 4 is a block and schematic diagram generally illustrating a human-machine interface, according to one example.

FIG. 5 is a block and schematic diagram generally illustrating a human-machine interface, according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Human-Machine Interfaces (HMI) enable interaction between users and machines, such as a computing device, for example. Traditionally, HMIs have interfaced interactions between users and computing devices via physical input devices (such as keyboards, mice, and touchpads, for example) and physical output devices (such as displays, speakers, and printers, for example). Relatively recently, HMIs have expanded to enable so-called “virtual” or “non-tactile” interactions, such as voice (e.g., virtual assistants) and video inputs (e.g., face recognition for security), for example.

HMIs should provide users with a frictionless (e.g., intuitive and seamless interaction to automatically and dynamically adjust and enable various modes of interfacing with a user with little to no user direction) and responsive (e.g., low-latency, content rich) experience. However, known HMIs enabling so-called “virtual” interactions typically focus on only a single type of interaction input (e.g., a personal assistant utilizing voice commands) and, thus, do not provide a robust interaction experience. Additionally, such known HMIs typically employ cloud-based machine learning (ML) processes which, by their nature, provides minimal data to express results, creates latencies in user interactions, and is not available when cloud connectivity is unavailable.

According to examples, the present disclosure provides an HMI system which evaluates any number of interaction inputs, both tactile inputs (e.g., keyboard, mouse, touchscreen) and non-tactile inputs (e.g., voice, visual, brain sensors), and dynamically integrates, adapts to and utilizes interaction content present in the interaction inputs (e.g., voice commands, gestures, gaze tracking) being employed by a user at any given time (e.g., more than one interaction input concurrently) to provide a user interface (UI) with a device with which the HMI operates (e.g., an edge device, such as PC, laptop, smartphone). According to examples, the HMI employs a plurality of ML models and hardware architectures (e.g., ML engines and interconnect structures) which are coordinated with one another and implemented at the edge computing device to provide a coherent UI having improved performance (e.g., rich content and low-latency experience) and which is available even without that device being connected to the network. Such an UI could also extend beyond a single device to span an ensemble of proximal devices. In examples, the HMI disclosed herein runs under an operating system (OS) of the edge computing device so as to be independent of the device CPU chipset and enhance security of the HMI system, and thereby also enabling deployment on a spectrum of devices employing multiple CPU types and models.

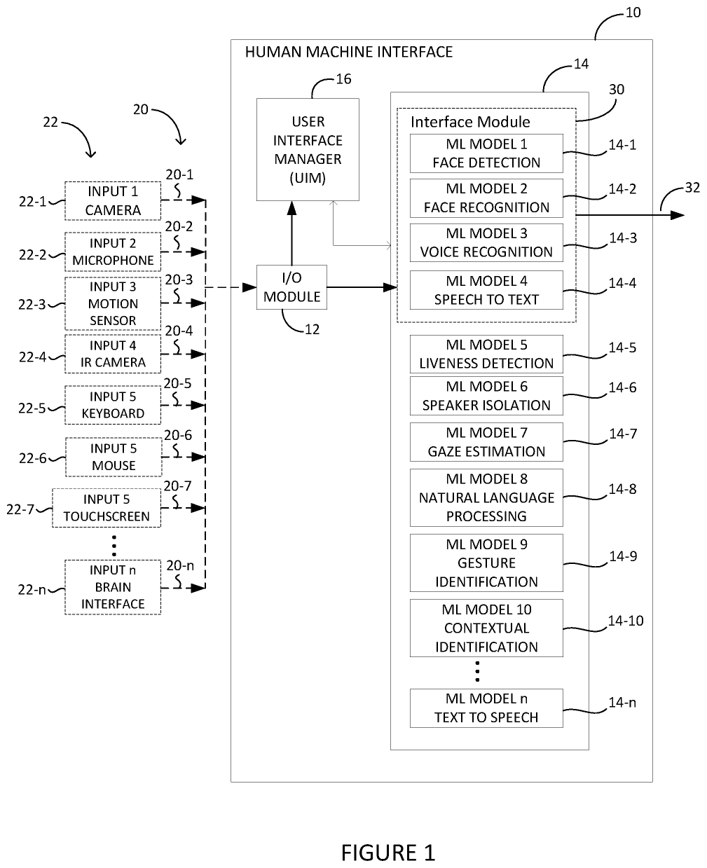

FIG. 1 is a block and schematic diagram generally illustrating an HMI system 10 to provide a user interface (UI) with a machine, such as an edge computing device, according to one example. In one example, HMI system 10 includes an input/output (I/O) module 12, a plurality of ML models 14, and a user interface manager (UIM) 16. I/O module 12 receives a plurality of interaction inputs 20, such as interaction inputs 20-1 to 20-n, where interaction inputs 20 may be received from a plurality of input devices 22, such as input devices 22-1 to 22-n. Examples of such input devices 22 may include a camera 22-1 providing an interaction input 20-1 comprising a video signal, a microphone 22-2 providing an interaction input 20-2 comprising an audio signal, a motion sensor 22-3 providing motion signals 20-3, an infrared camera 22-4 providing infrared image interaction input 20-4, a keyboard 22-5, mouse 22-6, and touchscreen input 22-7 providing conventional direct user input via interaction inputs 20-5, 20-6, and 20-7, respectively, and a brain interface device 22-n providing an interaction input 20-n comprising representations of brainwaves. Any number of interaction input sources 20 may be employed.

In examples, each interaction input 20 includes one or more types of interaction content. In examples, the types of interaction content may include “user interaction content” corresponding to different “user interaction modalities.” As used herein, the term “user interaction modalities” refers to ways or modes in which a user may interact with the computing device via HMI system 10. For example, video interaction input 20-1 received from camera 22-1 may include hand gestures, or other body gestures, of a user which serve as inputs (e.g., commands) to the computing device. For example, a swiping motion of a user's hand may indicate a “screen-scrolling” command, or a finger motion may indicate a “select” command (e.g., similar to a mouse click). Such hand/body gestures correspond to what may be referred to as a “gesture interaction modality”. Any number of different hand/body gestures may be employed to serve as inputs to the computing device via HMI system 10.

In another example, audio interaction input 20-2 received from microphone 22-2 may include a user's voice, which is converted to text, where such text may be used for voice dictation or as voice commands to the computing device. Such voice-to-text conversion corresponds to what may be referred to as a “voice interaction modality.” In another case, a voice interaction modality may combine a “lip reading functionality” derived from video interaction input 20-1 with audio interaction input 20-2 to improve a fidelity of the voice interaction modality. In each example, the user's gestures and lip movements present in video interaction input 20-1, and the user's voice present in audio interaction input 20-2 each represent “user interaction content”. Any number of different types of such user interaction content may be employed to enable any number of different types of user interaction modalities.

In other examples, in addition to user interaction content, the types of interaction content of interaction inputs 20 may include “contextual interaction content”. For example, video interaction input 20-1 received from camera 22-1 may include environmental elements, such as furniture (e.g., desks, tables), people, trees, etc., or may include images of a person sitting in front of the computer, which provide contextual information indicative of an environment in which the user is present and in which the computing device is operating. In examples, as will be described in greater detail below, such contextual interaction content may be employed by UIM 16 to determine which user interaction modalities to enable and provide as part of a UI of HMI system 10 at any given time. For example, if contextual interaction content indicates that the computing device is operating in a non-private area (e.g., video interaction input 20-1 may indicate a presence of multiple people), UIM 16 may elect to not employ a voice input modality. In another example, if contextual interaction content indicates a presence of a user, but such user is distanced from the computing device, UIM 16 may elect to employ a voice input modality, but not a gesture input modality. It is noted that, in addition to contextual interaction content being employed by UIM 16 to determine which types of user input modalities to enable at any given time, such may also be employed as part of a user interaction modality (e.g., a secure user interaction modality).

In examples, HMI system 10 includes a plurality of ML models 14, such as ML models 14-1 to 14-n. The plurality of ML models 14 may include any number of models trained to perform any number of different tasks. For example, ML models 14 may include a face detection model 14-1 to detect a presence of a human face, such as in video interaction input 20-1, a face recognition model 14-2 to identify particular human faces, such as in video interaction input 20-1, a voice recognition model 14-3 to identify a particular human voice, such as in audio interaction input 20-2, and a speech-to-text model 14-4 to convert speech in audio interaction input 20-2 to text, for example. In examples, some ML models (e.g., a group of ML models) of the plurality of ML models 14 may correspond to different user interaction modalities and process user interaction content from one or more interaction content inputs 20 corresponding to such user interaction modalities. In examples, some ML models (e.g., a group of ML models) of the plurality of ML models 14 may process contextual interaction content from one or more interaction content inputs 20 to provide contextual outputs indicative of contextual interaction content present in the interaction content inputs 20.

In examples, UIM 16 monitors interaction inputs 20 and, based on types of interaction inputs 20 which are present (e.g., video interaction input 20-1, audio interaction input 20-2, motion sensor interaction input 20-3, infrared camera interaction input 20-4, keyboard interaction input 20-5, mouse interaction input 20-6, touch screen input 20-7, and brain interface interaction input 20-n), dynamically adjusts a selected set of one or more user interaction modalities to employ as part of a user interface (UI) 30 of HMI 10 (as illustrated by a dashed line) via which a user can interact with the computing device, and dynamically adjusts a selected set of one or more ML models 14 to enable the selected set of user interaction modalities. In examples, as will be described in greater detail below, in addition to monitoring the types of user action inputs 20 which are available, UIM 16 analyzes contextual outputs indicative of contextual interaction content (e.g., location, surroundings, etc.), such as provided by some ML models 14, as described above. In other examples, as will be described in greater detail below. UIM 16 adjusts the set of selected user interaction modalities and the set of selected ML models 14 based on a set of operating policies.

As mentioned above, and as will be described in greater detail below, user interaction modalities are modes or ways in which HMI system 10 enables a user to interact with the computing device (or, more broadly, a machine). Examples of such user interaction modalities include Voice Interaction (such as speech-to-text and lip-reading-to-text, for example), Text-to-Voice Interaction, Gaze Interaction, Gesture Interaction (such as by using video and/or motion sensing, for example), Brain Interaction (such as via brain interface/brain “cap”), Haptic Interaction, Direct User Interaction (keyboard, mouse, touchscreen, etc.), and Secure Interaction (Face Recognition, Voice Recognition, Liveness Detection, etc.). Additionally, any combination of such modalities may be considered as defining further modalities. As described above, each user interaction modality may employ multiple types of interaction content from multiple interaction sources.

In examples, UIM 16 implements a UI 30 (dashed box in FIG. 1) including ML models 14 of the currently selected set of ML models 14, with the ML models of the selected set of ML models 14 interconnected with one another and with I/O module 12 via an interconnect structure, the interconnected ML models 14 to process and convert user interaction content corresponding the currently selected set of user interaction modalities (received via corresponding interaction inputs 20) to operational inputs 32 for the machine (e.g., an edge computing device). As indicated in FIG. 1, in examples, fewer than all ML models of the plurality of ML models 14 may be selected to implement UI 30.

In examples, as will be described in greater detail below, the operational inputs 32 are additionally converted/translated by HMI 10 to a format compatible with the machine. For example, in one case, HMI 10 includes a module that converts output from user interaction modalities to keyboard/mouse input formats such that the operational inputs 32 appear to the edge computing device as originating from a keyboard and/or mouse. In examples, operational inputs 32 may be translated to any suitable format recognized by the machine.

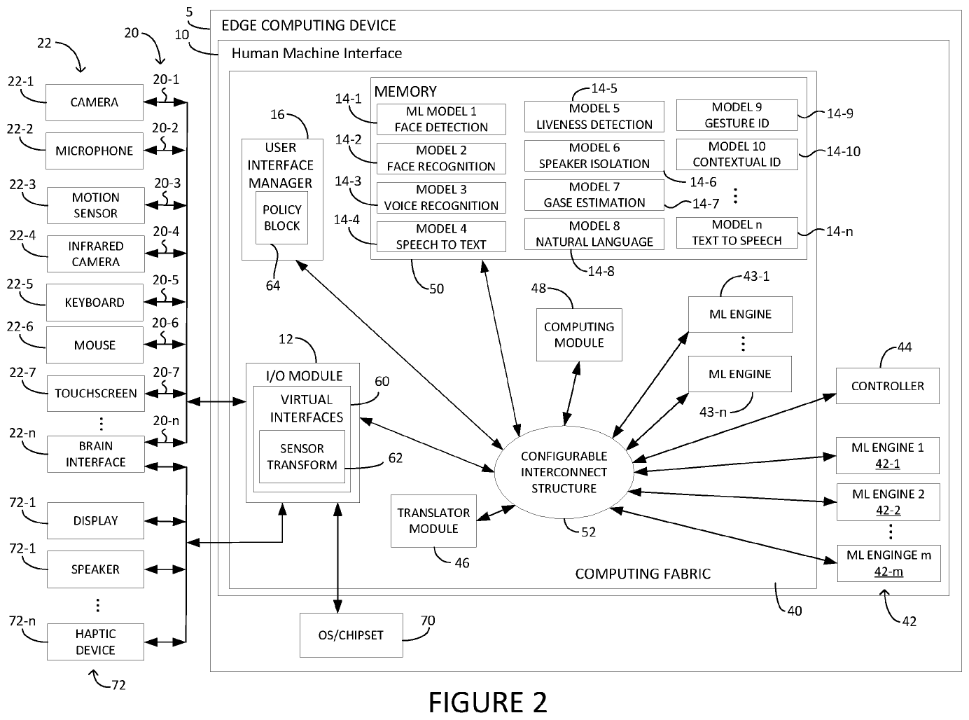

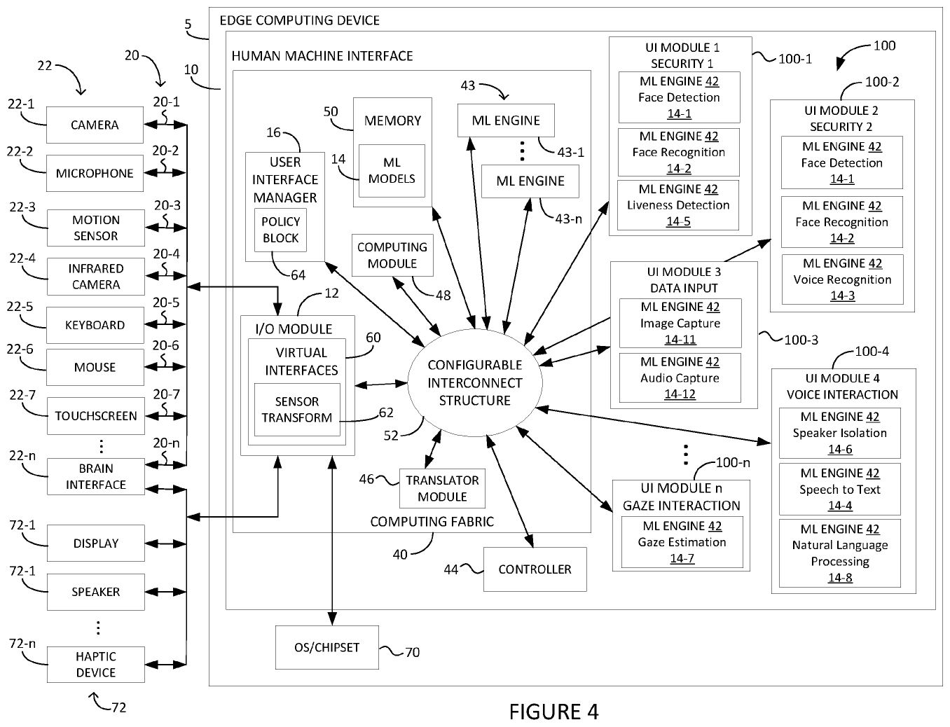

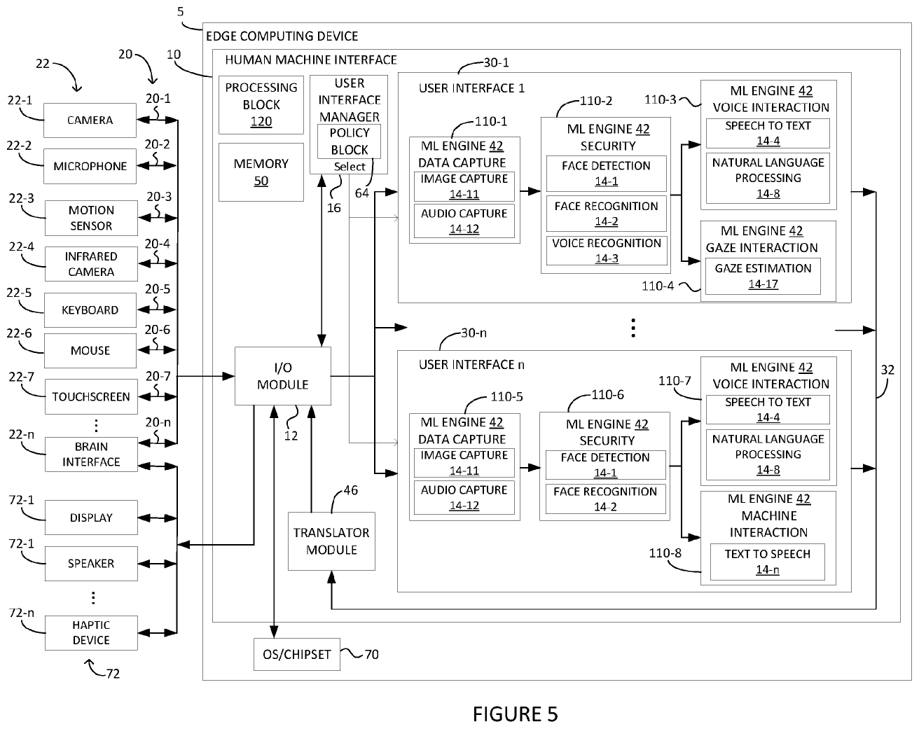

As will be described in greater detail below, in one example, UIM 16 implements UI 30 by instantiating selected ML models 14 on a number of ML engines and interconnecting the selected ML models 14 and ML engines via a configurable interconnect structure as part of a reconfigurable computing fabric (e.g., see FIG. 2). In one example, UIM 16 implements UI 30 by interconnecting preconfigured interface modules via a configurable interconnect structure as part of a reconfigurable computing fabric, where each preconfigured interface module is implemented to provide a corresponding user interaction modality (e.g., see FIG. 4). In another example, UIM 16 implements UI 30 by selecting one of a number of preconfigured user interfaces (e.g., see FIG. 5). By monitoring interaction inputs 20 and corresponding interaction content to dynamically adjust the user interaction modalities by which a user is able to interact with an associated machine with little to no user direction, HMI 10 in accordance with the present disclosure provides a user with a frictionless interaction experience.

FIG. 2 is a block and schematic diagram generally illustrating HMI 10, according to one example, implemented as a subsystem of an edge computing device 5, where edge computing device includes an operating system (OS) implemented on a central processing unit (CPU) chipset 70. In one examples, HMI 10 operates as a companion system to OS/chipset 70. In examples, HMI 10 includes a reconfigurable computing fabric 40, a number of ML engines 42, illustrated as ML engines 42-1 to 42-m, and a controller 44 for controlling configurations of reconfigurable computing fabric 40. In one example, I/O module 12 and UIM 16 are implemented as programmable logic blocks of computing fabric 40. In one example, HMI 10 includes a programmable logic block implemented as a translator module 46 to translate operational inputs 32 (see FIG. 1) to a format recognized by edge computing device 5. In one example, a programmable logic block is implemented as a computing module 48 and configurable to perform computing and logic operations, for example, on reconfigurable computing fabric 40. In examples, programmable logic blocks, including I/O module 12, UIM 16, computing module 48, and any number of other suitable modules, may be implemented using hardware and software elements. Although primarily described and illustrated as operating as a companion system to an operating system (e.g., an operating system of an edge computing device), HMI 10, in accordance with the present disclosure may operate independently from an operating system such that operational input 32 provided by HMI 10 may include inputs for devices other than or in addition to an operating system.

In examples, the plurality of ML models 14 are stored in a memory 50 implemented on computing fabric 40. In other examples, ML models 14 may be stored in locations remote from computing fabric 40. In other examples, storage of ML models 14 may distributed across various locations. In examples, reconfigurable computing fabric 40 includes a configurable interconnect structure 52 which is configurable to provide a data path structure to interconnect the elements of HMI 10 including programmable logic blocks (e.g., I/O module 12, UIM 16, translator module 46, computing module 48), memory 50, ML engines 42, and with inputs and outputs of computing fabric 40. In examples, hardware and software configurations and capabilities of the programmable logic blocks, and capabilities of configurable interconnect structure 52 may be modified via interaction with controller 44. In one example, computing fabric 40 comprises a field programmable gate array (FPGA).

In examples, as described above, UIM 16 monitors the plurality of interaction inputs 20 to determine which types of interaction inputs are available to HMI 10. In some examples, the types of input devices 22 may vary depending on the edge computing device 5. For example, in some cases, the plurality of available input devices 22 may include visible spectrum camera 20-1, microphone 20-2, keyboard 22-5, and mouse 22-6, for example. In other cases, the plurality of input devices 22 may further include motion sensor 22-4 and infrared camera 22-4. Any number of combinations of types of input devices 22 may be available with a given computing device 5. In some examples, input devices 22 may further include network endpoints (e.g., online sensor data) or data stored in local and/or remote storage devices (e.g., images, audio recordings).

In one example, I/O module 12 includes operations to provide virtual interfaces 60 to communicate with input devices 22. In one example, in addition to providing interfaces 60 to communicate with physical input devices (e.g. input devices 22-1 to 22-n), I/O module 12 includes operation to provide virtual input device interfaces, where such virtual input devices are created by I/O module 12 by employing processing logic to implement an input transform 62 to transform one or more interaction inputs 20 from physical input devices 22-1 to 22-n to obtain a virtual interaction input which representative of an interaction input not provided by the one or more interaction inputs 20. For example, in a case where a camera 22-1 is available, but a physical motion sensor device (such as motion sensor 22-3) is not, UIM 16 may instruct I/O module 12 to employ processing logic to execute input transform 62 to transform video interaction input 20-1 to a virtual interaction input representative of a motion sensor input.

In other examples, even is a case where a physical motion sensor is present, UIM 16 may instruct I/O module 12 to create a virtual motion sensor input by transforming a camera input, and subsequently select between using the physical motion sensor input (e.g., interaction input 20-3) and the virtual motion sensor interaction input based on operating policies. For example, UIM 16 may select a virtual motion sensor input created from a video input when an operating policy requires a high degree of accuracy, and may select a motion sensor input from physical motion sensor 22-3 when an operating policy requires a low-latency response.

In examples, as described above, UIM 16 monitors the plurality of interaction inputs 20 to determine which types of interaction inputs are available to HMI 10 (including created “virtual inputs”) and, based upon the available interaction inputs 20, selects which user interaction modality, or modalities, to employ when implementing UI 30 (e.g., voice interaction modality, gesture interaction modality, gaze estimation modality, etc.). In examples, after selecting the modalities to employ, UIM 16 selects which ML models 14 to load onto which ML engines 42 and, via configurable interconnect structure 52, interconnects the selected ML models 14 and ML engines 42 with an interconnect structure to implement the one or more selected user interaction modalities.

In some examples, similar to that described above with regard to interaction inputs 20, UIM 16 selects which ML models 14 and the ML engines 42 on which to the load the selected ML models 14 to implement the selected user interaction modalities based on a number of operational policies that may be in place, such as illustrated by policy block 64. Operational policies may include any number of factors and objectives such as required processing time, power consumption requirement (e.g., if HMI 10 is operating on battery power), and accuracy of ML processing results. For example, if there are two ML models 14 trained to provide similar outputs, such as face recognition models, for instance, UIM 16 may select to employ the ML model providing a more accurate result when a high accuracy of results is required, and may select to employ the model providing less accurate results, but which consumes less power, when HMI 10 is operating on battery power. In some examples, in addition to loading ML models 14 onto ML engines 42, depending on operating conditions (e.g., the capacity and availability of ML engines 42), UIM 16 may instantiate a number of ML engines 43 on computing fabric 40, such as illustrated by ML engines 43-1 to 43-n, and install selected ML models 14 on such instantiated ML engines 43.

In some examples, as described above, in addition to monitoring available types of interaction inputs 20, UIM 16 may monitor contextual interaction context present in interaction inputs 20. In examples, some ML models (e.g., a group of ML models) of the plurality of ML models 14 may such process contextual interaction content from one or more interaction content inputs 20 to provide contextual outputs indicative of contextual interaction content present in the interaction content inputs 20, such as illustrated by ML model 14-10. In one example, UIM 16 may install ML model 14-10 on an ML engine 42 to monitor contextual content of one or more interaction inputs 20, such as camera input 20-1 and microphone input 20-2, such as to determine whether edge computing device 5 is operating in a private or a public environment. In one example, UIM 16 may install ML model 14-1 on an ML engine 42 to monitor whether a person is positioned at the edge computing device 5. In examples, IM U16 may activate such context monitoring ML models 14 to continuously monitor the environment in which edge computing device 5 is operating. In some examples, context monitoring ML models 14 may be implemented separately from ML models 14 selected to implement selected user interaction modalities. In other examples, context monitoring ML models 14 may be activated to implement selected user interaction modalities while concurrently providing contextual information to UIM 16.

As described above, based on available types of interaction inputs 20 and contextual interaction context present in such interaction inputs 20, UIM 16 may implement a UI 30 including any number of user interaction modalities. As described above, such user interaction modalities include Voice Interaction (such as speech-to-text and lip-reading-to-text, for example), Text-to-Voice Interaction, Gaze Interaction, Gesture Interaction (such as by using video and/or motion sensing, for example), Brain Interaction (such as via brain interface/brain “cap”), Haptic Interaction, Direct User Interaction (keyboard, mouse, touchscreen, etc.), Augmented Direct User Interaction (e.g., text autofill/suggestions), and Secure Interaction (Face Recognition, Voice Recognition, Liveness Detection, etc.).

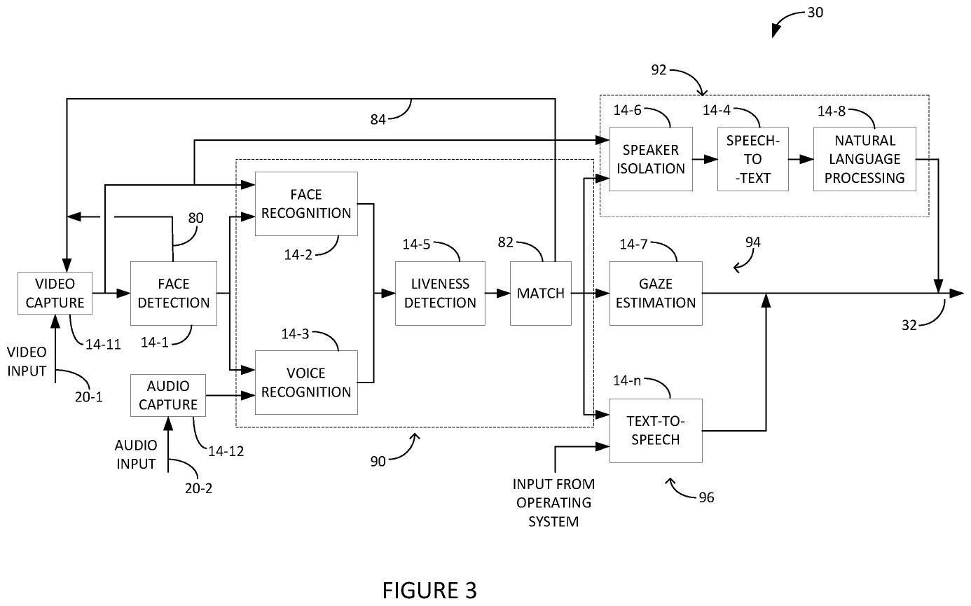

FIG. 3 is a block and schematic diagram generally illustrating an example of a UI 30 implemented by UIM 16 to provide selected user interaction modalities using selected ML models 14 implemented on one or more ML engines 42 and 43 and interconnected via configurable interconnect structure 52. It is noted that FIG. 3 illustrates a logical/operation flow diagram for UI 30 and is not necessarily intended to illustrate physical interconnections between elements of HMI 10. It is further noted that UI 30 represents one instance of UI 30 provided by HMI 10, and that such instance may be dynamically adjusted by UIM 16 to include different ML models 14 and interconnections there between based on monitoring of interaction inputs 20 and contextual inputs.

According to the illustrated example, UI 30 includes ML model 14-1 for face detection (detects whether a face is present in the input image data), ML model 14-2 for face recognition (check if the detected face belongs to a known person), ML model 14-3 for voice recognition (check if a voice belongs to a known person), ML model 14-5 for liveness detection (verify if the detected face is a living person or a reproduction), ML model 14-6 for speaker isolation (isolate audio of the detected person from a noisy environment), ML model 14-4 for speech-to-text conversion (convert audio of the detected person to text), ML model 14-8 for natural language processing (to distinguish speech intended as commands from speech intended as dictation, for example), ML model 14-7 for gaze estimation (to estimate a region on a monitor where the detected person is looking), ML model 14-n for text-to-speech conversion (convert text to audio output), ML model 14-11 for image input capture (extract image content from the camera to use as input for other ML models), and ML model 14-12 for audio input capture (extract audio from a microphone or audio file to use as input for other ML models).

In one example, ML model 14-11 receives video input 20-1 from camera 22-1 and provides image content in a suitable format to ML model 14-1 for face detection. If a face is not detected, ML model 14-1 continues to receive image content from ML model 14-11, as indicated by arrow 80. If a face is detected by ML model 14-1, ML model 14-2 for face recognition is activated to process image content from ML model 14-11, and ML model 14-3 is activated to process audio content received in a suitable format from ML model 14-12 as processed by ML model 14-12 from microphone 22-2. In one example, if a person is recognized by ML model 14-2 (such as by comparing the image content to stored images of known persons), and if a voice is recognized by ML model 14-3 (such as by comparing the audio content to stored audio files of known persons), ML model 14-5 processes image content and audio content to determine whether the person detected by face recognition ML model 14-2 is a live person, as opposed to a representation of such person (e.g., a still image). In one example, if ML model 14-5 asses that the detected person is a live person, a logic block 82 determines whether the voice recognized by ML model 14-3 matches the person recognized by ML model 14-2. If there is a mismatch, logic block 82 returns the process to receiving video input via ML model 14-11, as indicated by arrow 84. In one example, logic block 82 may be implemented as part of computing module 48 (see FIG. 2).

In one example, ML models 14-2, 14-3, 14-5 and logic block 82 together provide a secure interaction modality 90, ML models 14-6, 14-4, and 14-8 together provide a voice interaction modality 92, ML model 14-7 provides a gaze interaction modality 94, and ML model 14-n provides an machine audio interaction modality 96. It is noted that such user interaction modalities may be implemented using different models depending on the available interaction inputs 20 and contextual input. For example, in some cases, secure interaction modality 90 may not include voice recognition ML model 14-3 and liveness detection ML model 14-5, but only employ face recognition ML model 14-2. Similarly, in other cases, voice interaction modality 92 may not include speaker isolation ML model 14-6.

If logic block 82 determines that the voice recognized by ML model 14-3 matches the person recognized by ML model 14-2, voice interaction modality 92, gaze interaction modality 94, and machine audio interaction modality 96 are activated to process audio, video, and text data to provide operational inputs 32 to edge computing device 5, such as to OS/chipset 70 of edge computing device 5 (see FIG. 2). In one example, as mentioned above, operational inputs 32 are directed to translator module 46 to convert the operational inputs 32 to conventional input formats compatible with and recognized by edge computing deice 5. In examples, translator module 46 converts operational inputs 32 to conventional keyboard and mouse data formats. In one example, gaze interaction modality 94 tracks where a user is looking on a monitor or screen and provides operational inputs 32 to cause a cursor to move with the person's gaze. In one example, machine audio interaction modality 96 provides operational inputs 32 resulting in audio communication of the computing device with the user, such as via speaker 72-1 (see FIG. 2).

FIG. 4 is a block and schematic diagram generally illustrating HMI 10, according to one example of the present disclosure. The implementation of HMI 10 of FIG. 4 is similar to that of FIG. 2, however, rather than dynamically instantiating each ML model 14 on an ML engine 42 and interconnecting the instantiated models via configurable interconnect structure 52 to enable different user interaction modalities in response to changes in user interaction, a plurality of user interaction modules 100, illustrated as user interaction modules 100-1 to 100-n, are pre-configured, with each user interaction module 100 enabling a different user interaction modality or a user interface functionality.

For example, UI module 100-1 includes face detection ML model 14-1, face recognition ML model 14-2, and liveness detection ML model 14-5 instantiated on one or more ML engines 42 and interconnected with one another via configurable interconnect structure 52 to provide a first security interaction modality. UI module 100-2 includes face detection ML model 14-1, face recognition ML model 14-2, and voice recognition ML model 14-3 instantiated on one or more ML engines 42 and interconnected with one another via configurable interconnect structure 52 to provide a second security interaction modality. UI module 100-3 includes image input capture ML model 14-11 and audio input capture ML model 14-12 instantiated on one or more ML engines 42 and interconnected with one another via configurable interconnect structure 52 to provide a data input functionality. UI module 100-4 includes speaker isolation ML model 14-6, speech to text ML model 14-4, and natural language processing ML model 14-8 instantiated on one or more ML engines 42 and interconnected with one another via configurable interconnect structure 52 to provide a voice interaction modality. UI module 100-n includes gaze estimation ML model 14-7 implemented on an ML engine 42 to provide a gaze interaction modality.

According to the example implementation of FIG. 4, in response to monitoring interaction inputs 20 and/or contextual information representative of an environment in which edge computing device 5 is operating, UIM 16 selects one or more UI modules 100, and interconnects the selected UI modules 100 via configurable interconnect structure 52 to provide a UI interface 30 enabling selected user interaction modalities. It is noted that any number of UI modules 100 implementing any number of user interaction modalities may be employed. It is also noted that additional UI modules 100 may be dynamically configured by UIM 16 in response to monitoring interaction inputs 20 and/or contextual information. While the implementation of FIG. 4 may employ more resources that the implementation of FIG. 2, having pre-configured UI modules 100 to enable selected user interaction modalities may enable HMI 10 to adapt to UI 30 more quickly to changing user interaction requirements.

FIG. 5 is a block and schematic diagram generally illustrating an implementation of HMI 10, according to one example of the present disclosure. Rather than employing a configurable computing fabric 40 having a configurable interconnect structure 52 to dynamically instantiate and interconnect ML models 14 on ML engines 42 to dynamically create and modify user interface 30 (such as illustrated by the implementations of FIGS. 2 and 4), the implementation of HMI 10 of FIG. 5 includes a plurality of pre-configured user interfaces 30, illustrated as user interfaces 30-1 to 30-n. In examples, each pre-configured UI 30 includes a number of ML models instantiated on a number of ML engines 42 to provide a number of user interface modules 110 which provide different functionalities and enable different user interaction modalities. In examples, the interface modules 110 are interconnected with one another to form the corresponding pre-configured user interface 30, with each pre-configured UI 30 enabling different combinations of user interaction modalities.

In one example, UI 30-1 includes a UI interface module 110-1 to provide data capture functionality for video and audio input, and UI interface modules 110-2, 110-3, and 110-4 to respectively provide security, voice, and gaze user interaction modalities. In one example, UI 30-n includes a UI interface module 110-5 to provide data capture functionality for video and audio input, and UI interface modules 110-6, 110-7, and 110-8 to respectively provide security, voice, and machine interaction modalities. Any number of pre-configured UI interfaces 30 may be implemented to enable any number of combinations of user interaction modalities.

In examples, based on monitoring of interaction inputs 20 and contextual information, and on operating polices defined by policy block 64, UIM 16, via a select output 120, dynamically activates a different UI 30 of the pre-configured plurality of user interface modules 30-1 to 30-n at any given time to enable selected user interaction modalities. The activated UI 30 receives interaction content via I/O module 12 for corresponding ML models 14 and converts interaction content representative of the selected user interaction modalities to operational inputs 32 for the computing device 5. In examples, operational inputs 32 are translated by translator module 46 to formats suitable for computing device 5. In examples, HMI 10 includes a memory 50 and a processing block 120 (e.g., a microcontroller) which, together, implement UIM 16 and translator module 46 and control operation of HMI 10.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A dynamic human-machine interface (HMI) to interface with a machine, comprising:
an input/output (I/O) module to receive a plurality of interaction inputs, each interaction input including one or more types of interaction content, the types of interaction content including user interaction content representing different user interaction modalities;
a plurality of machine learning (ML) models to process interaction content from one or more interaction inputs, the plurality of ML models including ML models corresponding to different user interaction modalities to process user interaction content representing the corresponding user interaction modality to provide one or more model outputs; and
a user interface manager to:
dynamically adjust a selected set of user interaction modalities and a selected set of ML models to enable the selected set of user interaction modalities based on monitoring of at least the user interaction content of the plurality of interaction inputs; and
implement a user interface including ML models of a currently selected set of ML models interconnected with one another with an interconnect structure to convert user interaction content corresponding to the currently selected set of user interaction modalities to operational inputs to the machine based on the model outputs of the currently selected ML models.

2. The dynamic HMI of claim 1, the types of interaction content including contextual interaction content representative of an operating environment, the plurality of ML models including ML models to process contextual interaction content to provide contextual outputs, the user interface manager to select the set of user interaction modalities and the set of ML models based on the contextual outputs.

3. The dynamic HMI of claim 1, the user interface manager to select the set of user interaction modalities and the set of ML models based on a set of operating policies, the operating policies including user and system objectives.

4. The dynamic HMI of claim 1, further including a translator module to convert the operational inputs to a format recognized by the machine.

5. The dynamic HMI of claim 1, including:
a plurality of ML engines; and
a reconfigurable computing fabric including a configurable interconnect structure, the user interface manager and I/O module implemented as programmable logic blocks on the reconfigurable computing fabric, the user interface manager to implement the user interface by instantiating the currently selected set of ML models on selected ML engines of the plurality of ML engines and interconnect the instantiated ML models with the interconnect structure via the configurable interconnect structure.

6. The dynamic HMI of claim 5, including:
a plurality of user interface modules, each user interface module including one or more ML models instantiated on one or more ML engines and interconnected to implement a corresponding user interaction modality;
the user interface manager to implement the user interface by interconnecting selected user interface modules of the plurality of user interface modules, the selected user interface modules including ML models of the currently selected set of ML models and having corresponding user interaction modalities of the currently selected set of user interaction modalities.

7. The dynamic HMI of claim 5, the user interface manager to provide virtual interfaces to receive each interaction input of the plurality of interaction inputs.

8. The dynamic HMI of claim 5, the user interface manager to control the I/O module to transform interaction content from one or more selected interaction inputs to form virtual interaction inputs including interaction content different from interaction content of the one or more selected interaction inputs.

9. The dynamic HMI of claim 1, including:
a plurality of user interfaces, each user interface including one or more ML models instantiated on one or more ML engines and interconnected to implement one or more corresponding user interaction modalities;
the user interface manager to implement the user interface by selecting a user interface from the plurality of user interfaces, the selected user interface including ML models of the currently selected set of ML models and having corresponding user interaction modalities of the currently selected set of user interaction modalities.

10. A dynamic human-machine interface (HMI) to interface with a machine, comprising:
a plurality of machine learning (ML) engines;
a reconfigurable computing fabric including:
a configurable interconnect structure; and
a number of programmable logic blocks including:
an input/output module to receive a plurality of interaction inputs, each interaction input including one or more types of interaction content, the types of interaction content including user interaction content representing different user interaction modalities;
an interface manager; and
a plurality of ML models to process interaction content from one or more interaction inputs, the plurality of ML models including ML models corresponding to different user interaction modalities to process user interaction content representing the corresponding user interaction modality to provide one or more model outputs;
the interface manager to:
dynamically adjust a selected set of user interaction modalities and a selected set of ML models to enable the selected set of user interaction modalities based on monitoring of at least the user interaction content of the plurality of interaction inputs; and
implement a user interface including ML models of a currently selected set of ML models interconnected with one another with an interconnect structure to convert user interaction content corresponding to the currently selected set of user interaction modalities to operational inputs to the machine based on the model outputs of the currently selected ML models.

11. The dynamic HMI of claim 10, including:
a plurality of user interface modules, each user interface module including one or more ML models instantiated on one or more ML engines and interconnected to implement a corresponding user interaction modality;
the interface manager to implement the user interface by interconnecting selected user interface modules of the plurality of user interface modules, the selected user interface modules including ML models of the currently selected set of ML models and having corresponding user interaction modalities of the currently selected set of user interaction modalities.

12. The dynamic HMI of claim 10, the types of interaction content including contextual interaction content representative of an operating environment, the plurality of ML models including ML models to process contextual interaction content to provide contextual outputs, the interface manager to select the set of user interaction modalities and the set of ML models based on the contextual outputs.

13. The dynamic HMI of claim 10, the interface manager to select the set of user interaction modalities and the set of ML models based on a set of operating policies.

14. The dynamic HMI of claim 10, the programmable logic blocks including a translator module to convert the operational inputs to a format recognized by the machine.

15. A device comprising:
an operating system running on a CPU chipset; and
a dynamic human-machine interface (HMI) including:
an input/output module to receive a plurality of interaction inputs, each interaction input including one or more types of interaction content, the types of interaction content including user interaction content representing different user interaction modalities;
a plurality of machine learning (ML) models to process interaction content from one or more interaction inputs, the plurality of ML models including ML models corresponding to different user interaction modalities to process user interaction content representing the corresponding user interaction modality to provide one or more model outputs; and
an interface manager to:
dynamically adjust a selected set of user interaction modalities and a selected set of ML models to enable the selected set of user interaction modalities based on monitoring of at least the user interaction content of the plurality of interaction inputs; and
implement a user interface including ML models of a currently selected set of ML models interconnected with one another with an interconnect structure to convert user interaction content corresponding to the currently selected set of user interaction modalities to operational inputs to the operating system based on the model outputs of the currently selected ML models.
